(19) United States
(12) Patent Application Publication
(10) Pub. No.: US 2002/0064040 A1
(43) Pub. Date: May 30, 2002

(54) Multi-purpose office tool

(76) Inventor: Stephen J. Padden, Ventura, CA (US)

Correspondence Address: KENNETH J HOVET LAW OFFICES, 4476 MARKET ST, SUITE 601, VENTURA, CA, 93003, US

(21) Appl. No.: 10/015,191

(22) Filed: Nov. 21, 2001

Related U.S. Application Data
(60) Provisional application No. 60/252,695, filed on Nov. 24, 2000.

(51) Int. Cl. B25B 23/18

(52) U.S. Cl. 362/119

(57) ABSTRACT

A multipurpose tool in accordance with the present invention includes a hole punch and a stapler that are selectively engaged with a housing. The housing includes a recess defined by an inclined wall and an end wall that extend from a respective housing sidewall and bottom wall and merge into each other at a curved portion. The inclined wall, curved portion and end wall include opposing undercut slots which engage corresponding flanges on an actuating member of the stapler when the stapler is attached thereto. The housing includes a corner opening and opposing guide rails that extend from the housing front and rear walls into the corner opening. The guide rails engage corresponding grooves in a punch casing when the hole punch is inserted into the corner opening. This structure allows for the stapler/hole punch to be detached and used as a stand-alone implement, or used when fixed to the housing. When fixed to the housing, a greater force can be imparted through the housing to the stapler/hole punch for improved operation.

This application claims priority from Provisional Application Serial No. 60/252,695, which was filed Nov. 24, 2000.

### FIELD OF THE INVENTION

The present invention pertains generally to tools. More specifically, the present invention pertains to palm-sized multi-purpose tools. The present invention is particularly, but not exclusively, useful as a multi-purpose tool with a variety of implements to provide an office environment while the user is traveling.

### BACKGROUND OF THE INVENTION

Small, multi-function tools and implements such as pocket knives and the like are known in the prior art. These types of tools usually contain a variety of implements which are typically pivotably mounted to a housing and casing. During use, the implement is typically pivoted away from the casing and into a fixed, extended position in order to operate the implement.

One of the disadvantages of these types of tools, however, is that the utility of the tool is limited because the implement is so small that very little actuating force can be placed thereon without breaking either the implement or the tool housing that the implement is attached to. Another disadvantage is that because the implement is permanently fixed to the parent housing, the implements cannot be detached from the parent housing and used by themselves. This is probably just as well, as the detached implement would have no housing/gripping surface of its own, and, hence, no means of applying an actuating force for operation.

Some examples for enclosing miniaturized implement in thin housings are shown in U.S. Pat. No. 4,934,528, No. 973,930, No. 464,405 and No. 2,412,0506. The patented devices shown in the above patents most often utilize hinges, clasping mechanisms, pivot arms, levers and spring means. As a result, they are not convenient to carry as a personal item and they are oftentimes difficult to use. Further, these patents do not disclose miniaturized office implements such as punches, staplers, scissors, and the like which can either be used alone, or which cooperate with the housing to allow for a greater actuating force to be to be imparted through the housing to actuate the implement.

In light of the above, it is an object of the present invention to provide a multipurpose office tool containing a variety of miniaturized implements which are adapted for office use. It is another object of the present invention to provide a multipurpose office tool wherein the miniature office implements cooperate with the storage housing to allow for a greater actuating force to be use thereon. It is another object of the present invention to provide a multipurpose office tool wherein the miniature office implements can be selectively detached from the storage housing and used as stand-alone implements. It is another object of the present invention to provide a multipurpose office tool that is easy to use and convenient to manufacture.

### SUMMARY OF THE PRESENT INVENTION

A multipurpose office tool in accordance with the present invention includes a housing and a stapler having a base and an actuating member that is detachably mounted to the housing. When attached, the actuating member cooperates with the housing to allow for a larger, more effective actuating force to be imparted through the housing to the actuating member for operation of the stapler. Alternatively, the actuating member can be detached from the housing and the stapler can be operated alone by pressing the actuating member.

The housing includes a recess that is defined by an inclined wall that extends from a housing side wall and merges into a curved portion. The curved portion further merges into an end wall the extends upwardly from the housing bottom wall. A pair of undercut slots extend along the internal wall and the curved portion, with the undercut slots terminating at the end wall.

The actuating member includes opposing flanges that extend longitudinally along the actuating member. When the stapler is attached to the housing, the opposing flanges frictionally engage the corresponding undercut slots. Once attached, the stapler base is about flush with the bottom wall to provide a streamlined profile for the multipurpose tool that occupies a minimum of space.

The multipurpose tool of the present invention further includes a hole punch that is selectively attached to the housing. To do this, the housing includes a corner opening. The corner opening is defined by the parallel, spaced-apart front and rear walls of the housing, as well as by an inner punch wall and a punch lower wall that interconnect the front and rear walls. The inner punch wall extends vertically downward from a housing top wall and merges orthogonally into a punch lower wall that extends horizontally from an adjacent housing side wall. The front and rear walls are formed with a pair of horizontal, opposing guide rails.

The hole punch includes a punch casing that includes a pair of opposing grooves. When the hole punch is fixed to the housing, the hole punch is inserted into the corner opening, which causes the grooves in the punch casing to frictionally engage a corresponding guide rail in the corner opening. The housing also includes paper insertion slots in the housing that align with the working slot of the hole punch. In this manner, material to be punched can be inserted into paper slots, and the housing can be used to impart a greater force on the hole punch in the same manner as for the stapler described above. Alternatively, the hole punch can be removed from the corner opening and used as a stand-alone implement.

The multipurpose tool of the present invention also includes a scissors, a laser pointer, a screwdriver, knife and a miniature implement. The scissors and miniature implement are selectively detachable from the housing. Further the miniature housing also cooperates with the housing to allow for a greater force to be imparted thereto in the same manner as for the stapler and hole punch discussed above. The laser pointer and screwdriver and knife are permanently attached to the housing so that the housing maintains the streamlined profile cited above.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a front isometric view of the overall tool of the present invention showing a housing containing multiple implements.

FIG. 2 is a rear isometric view of the overall tool of FIG. 1.

FIG. 3 is a left side elevational view of the tool housing shown in FIG. 1.

FIG. 4 is a right side elevational view of the tool housing shown in FIG. 3.

FIG. 5 is a top plan view of the tool housing shown in FIG. 3.

FIG. 6 is a bottom plan view of the tool housing shown in FIG. 3.

FIG. 7 is an elevational view of the back interior wall of the tool of FIG. 1.

FIG. 7a is an enlarged fragmentary view taken along line 7a-7a in FIG. 7.

FIG. 8 is an elevational view of the front interior wall of the tool of FIG. 1.

FIG. 9 is a fragmentary exploded front isometric view of the tool of FIG. 1.

FIG. 10 is a fragmentary exploded rear isometric view of the tool of FIG. 1.

### WRITTEN DESCRIPTION OF THE PREFERRED EMBODIMENT

Referring to the Figures, the multi-purpose tool of the present invention is shown and is designated generally by reference 10. The tool includes a housing 12 with a front wall 14 spaced-apart from a back wall 16. The front wall and back wall have mirror-image outlines and are secured together to form the overall pocket-sized housing.

The periphery of the housing is defined by a first side wall 18, a second side wall 20, a top wall 22 and a bottom wall 24. The first side wall, second side wall, top wall and bottom wall combine to provide the housing with flat exterior faces and a generally rectangular outline. Round, oval and other polygonal outlines could also be used.

Although the housing specifically described and shown herein defines a generally open interior, the housing could alternatively comprise a multi-layered laminate or a unitary molded piece. Accordingly, all references herein to any front, back, first side, second side, top and bottom “wall” shall also mean the front, back, first, second, top and bottom sides of the housing no matter how the housing was constructed.

First side wall 18 extends from a lower corner 19 upwardly to implement corner 28. Top wall 22 extends from the implement corner 28 rearwardly to punch corner 29. The second side wall 20 extends downwardly from punch corner 29 and terminates at scissors corner 32. The bottom wall 24 extends forwardly to a midpoint corner 33 from which extends end wall 34 of stapler recess 38.

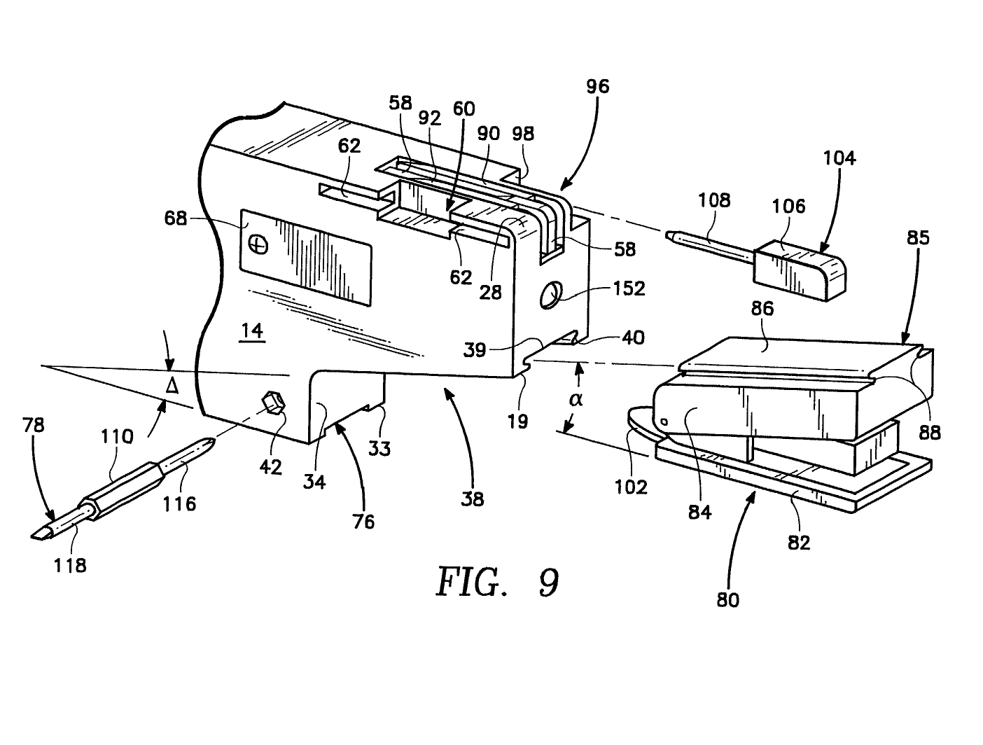

An arcuate indentation 76 extends into the surface of bottom wall 24. As best shown in FIGS. 6 and 9, the indentation begins at midpoint corner 33 and extends rearwardly about one-third the length of bottom wall 24 toward scissors corner 32. The indentation is bilaterally symmetrical with the midline of bottom wall 24 and has a width at corner 33 that is over half of the bottom wall width. Opposing sides of the indentation curve inwardly and meet at a terminal end portion 77.

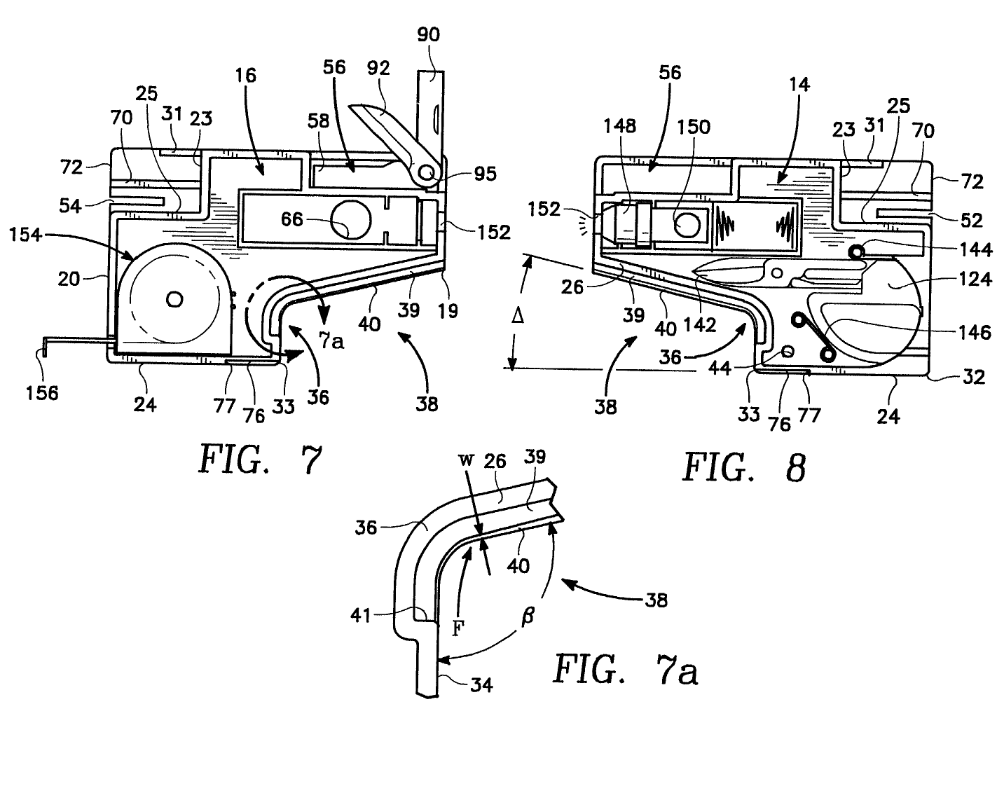

The stapler recess 38 is defined by the upwardly extending end wall 34 which merges at curved portion 36 with inclined wall 26. The inclined wall extends upwardly and outwardly at an obtuse angle (β) from end wall 34 to lower corner 19 of first sidewall 18 (See FIG. 7a).

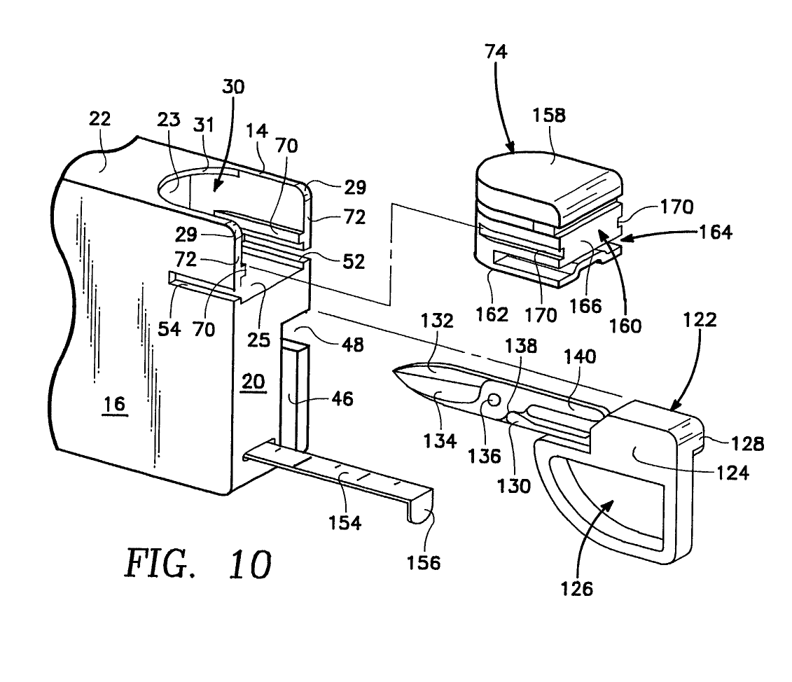

With reference to FIG. 10, punch corner 29 is provided with a punch opening 30. This is defined by a punch lower wall 25 which is offset downwardly from the punch corner and extends inwardly from second side wall 20. It intersects with upwardly extending inner punch wall 23. The inner punch wall 23 terminates at the underside of housing top wall 22 at a juncture inward from the top wall curved edge 31. The lower punch wall and inner punch wall cooperate with interior front and back wall structures to provide a containment space for punch 74 in a manner to be hereinafter described.

As best seen in FIGS. 7-8 and 10, the front and back walls of the punch opening include respective opposing paper insertion slots 52, 54. The slots cooperate with a corresponding slot structure in punch 74 to permit insertion of paper sheets for hole punching to be hereinafter described.

The punch opening further includes a pair of opposing raised guide rails 70, 70 extending inwardly from respective inner surfaces of front wall 14 and back wall 16. The guide rails extend rearwardly from a respective side edge 72, 72 of the front wall to inner punch wall 23. The guide rails engage corresponding grooves 170 in punch 74 to releasably retain the punch within the punch opening.

The inclined wall 26 and curved portion 36 of stapler recess 38 are provided with an elongated inner groove 39. The groove extends from lower corner 19 to a recess shoulder 41 located proximate the midportion of end wall 34.

On each opposing side of the inner groove 39 is an undercut slot 40. The width (w) of the slots corresponds to the thickness of flanges 88, 88 of stapler 80. The slot widths are uniform throughout their length except in the forward section (F) of the curved portion 36. As best shown in FIG. 7a, the width diminishes by an amount that is sufficient to create a frictional hold on flanges 88, 88. The location of the forward section will correspond to the length of stapler casing 84 so that the full length of the stapler will be entirely within recess 38 when flanges 88, 88 are releasably constrained by the diminished widths of undercut slots 40, 40.

The tool housing 12 includes a polygonal socket 42 which is recessed into the lower portion of front wall 14 between recess end wall 34 and second side wall 20. Preferably, the socket is located adjacent the recess end wall, although other locations on the front wall (or rear wall) are envisioned. The socket is formed with an implement opening 44 for insertion of an implement 78 in a manner set forth in the inventor's co-pending U.S. patent application Ser. No. 09/404,462 filed Sep. 24, 1999 for an invention entitled “Combined Pocket Implements With Multi-Function Housing”.

Second side wall 20 of the housing is provided with a somewhat rectangular scissors niche 46. The scissors niche includes upper detent slot 48 which is formed in rearwall 14.

The above niche and detent slot housing openings are sized and oriented to engage a scissors 122. The scissors comprises a handle 124 which is formed with a finger opening 126. The handle includes an offset base part 128 which extends laterally for engagement with the aforementioned upper detent slot 48. An elongated resilient member 130 has a proximal end fixed to the handle and a free end 131 that abuts blade notch 138 of pivot blade 134.

Adjacent to the resilient member 130 is stationary blade 132. The stationary blade is secured to the handle and extends outwardly in a direction about parallel with the resilient member. The pivot blade is pivotally attached with swivel pin 136 to the midportion of the stationary blade so that their respective blade portions will move across each other to effect a cutting action. When the resilient member is unflexed, the pivot blade will be apart from stationary blade 132. When pivot arm 140 of the pivot blade is moved toward the stationary blade and against the bias of resilient member 130, the aforesaid cutting action will occur. This most conveniently occurs when an operator has one finger in finger opening 126 and a thumb pressing against pivot arm 140.

For storage, the pivot blade and stationary blade are longitudinally aligned against the bias of resilient member 130. Then the scissors is moved into scissors niche 46. Simultaneously, handle offset base part 128 will slide into upper detent slot 48. Within the housing, the pointed ends of the blade 142, 142 abut the inside surface of the inclined wall 26 (See FIG. 8). The tension in the resilient member urges the pivot blade against an internal boss 144 within the housing. Also, the finger portion of the handle abuts a housing stop 146 that is located internally within the housing. With the above interfitting parts and enhanced frictional engagement caused by the resilient member, the scissors will be held securely in the housing.

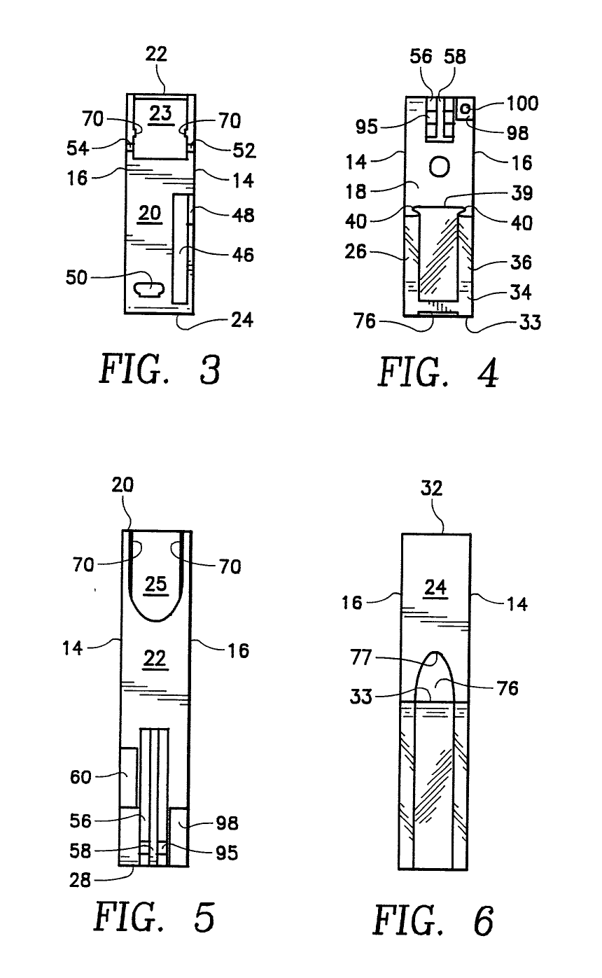

As best seen in FIGS. 3 and 10, a transverse tape measure slot 50 is formed in the second side wall between scissors niche 46 and rear wall 16. The tape measure slot is oriented parallel to bottom wall 24. A measuring tape 154 is mounted within the housing with a tape recoiling means in a manner known in the art. The tape end extends through the tape measure slot and terminates at a lip 156. The lip prevents the end of the measuring tape from retracting into the housing and allows for convenient access to the working end of the measuring tape.

The top wall of the housing is formed with an elongated corner opening 56 which extends from the implement corner 28 along a portion of the top wall toward punch corner 29. An internal cross bar 95 (See FIG. 4) extends transversely across the corner opening near implement corner 28. A screwdriver 90 and a knife blade 92 are pivotably mounted to the cross bar. The corner opening has a depth and a longitudinal length sufficient for stowage of both the screwdriver and knife. One of more other tools could replace the above knife and screwdriver such as an awl, can opener, bottle opener, corkscrew and file.

An implement partition 58 is attached to the housing and extends along a major portion of the corner opening midline. The partition separates the screwdriver from the knife.

Adjacent to the elongated corner opening is a pen notch 96. The pen notch has an L-shaped cross-section that opens into back wall 16. The notch extends a predetermined distance from implement corner 28 by an amount about equal to the length of pen handle 106 of pen 104. The notch terminates at upstanding notch end 98. A pen point orifice 100 extends coaxially from the notch end into the housing (see FIG. 4) to permit insertion of pen shaft 108. The pen handle and notch have co-extensive shapes so that the pen handle, when stowed in the notch, will have an outline co-planar with the housing back wall and top wall.

The top wall of the housing proximate the implement corner is further formed with an implement notch 60. Implement notch 60 is parallel to corner opening 56 and extends downwardly into the housing from the top wall. Opposing edges of the implement notch merge into respective opposing working slots 62, 62 which are recessed into the front wall, as best seen in FIG. 9.

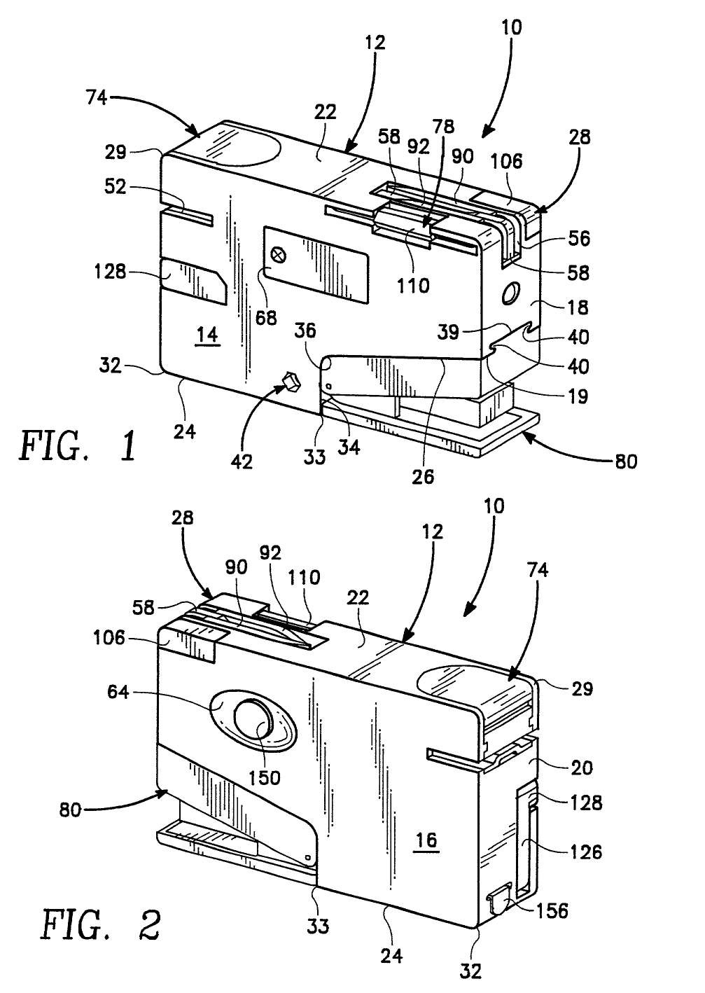

Fitted into the implement notch and opposing slots is a multi-faceted implement 78. the implement has an implement casing 110 with a diameter about equal to the depth of implement notch 60 discussed above. As shown in FIG. 9, first and second implement working parts 116, 118 extend coaxially from respective opposing ends of casing 110. When the implement casing is inserted into implement notch 60 for storage, the working parts move into implement slots 62, 62. As best shown in FIG. 1, the implement slots have a width less than the diameter of the working parts so that an effective frictional engagement occurs with each working part to maintain the overall implement in a secure stowed position.

As shown, the first working part 116 comprises the end portion of a Phillips screwdriver and the second working part 118 comprises the end portion of a flat-bladed screwdriver. The working parts could also comprise Allen wrenches, sockets, drill bits, awls, punches, files, scribes and similar types of working tools.

It is to be appreciated that the term “implement casing” is intended to encompass not only the hexagonal structure shown and describe above, but also structures having an oblong, oval, triangular or other polygonal shapes when viewed in cross-section.

The utility of the multi-purpose tool is increased by including a stapler 80. The stapler comprises a base 82 and an actuating member 85 that is pivotably attached to the base in a manner known in the prior art for staplers. Typically, a torsion spring biases the base and actuating member angularly apart. The top surface 86 of the actuating member includes a pair of opposing longitudinal flanges 88, 88, as best seen in FIGS. 1 and 9. The flanges frictionally engage corresponding undercut slots 40, 40 of housing groove 39 for detachably mounting the stapler to the housing.

The stapler has an angle a between base 82 and surface 86 of the actuating member 85. This angle is about equal to, or preferably greater than, angle A between the bottom wall 24 of the housing and inclined wall 26 of stapler recess 38 (best seen in FIGS. 8 and 9). The corresponding angles a and A allow for the stapler and the recess to have approximately the same profile. This configuration allows the stapler to fit within the recess when stowed, while maintaining an overall rectangular profile for the overall tool.

An end tab 102 extends co-extensively outward from the rear edge of stapler base 82, as seen in FIG. 9. The tab has an outline that matches indentation 76 of bottom wall 24. In this way, the tab will engage the indentation when the stapler is stowed within the recess. When angle a of the stapler is slightly greater than recess angle A, the tab will function to leverage the stapler base toward the stapler casing. Since the stapler has an internal spring that always biases the base and casing apart, the tab causes an opposite force which enhances the frictional connection between the tab and its matching indentation. Additionally, the tab can have a narrow width and thin thickness so that it can function as a staple remover.

Still further, the tab assists in aligning the stapler base underside in a co-planar relationship with housing bottom wall 24. This provides for a continuous flat surface and allows the tool to rest in a stable manner upon a table top or the like.

It will also be appreciated that by having the stapler located in a lower corner of the housing, the larger size of the housing can be used as an adjunct casing part when punching down to effect a stapling action. Oftentimes, a fairly significant force is required to staple together multiple (or thick) sheets of paper, fabric, laminates, or other sheet materials. In these instances, having a greater leverage provided by pushing down on the overall housing, rather than just stapler casing 84, is a real advantage.

For further utility, the tool of the present invention includes a punch 74. The punch comprises an operating member 158 that is reciprocatingly mounted within punch casing 160. A punch base 162 is attached to the underside of the punch casing and is spaced-apart from the underside a distance sufficient to create a punch paper slot 164. The operating member 158 is provided with a downwardly extending punch bar that is aligned with a punch hole in punch base 162, as is known in the art for hole punches.

The slot 164 opens toward the punch front wall 166. When the punch is in a stowed position within housing punch opening 30, the slot 164 will be co-extensive with paper insertion slots 52, 54. Therefore, the punch may operate when in a stowed position by placing the edge of a paper into insertion slots 52, 54 simultaneous with paper slot 164 and pushing down on operating member 158. Alternatively, the punch may be removed and operated alone without benefit of the larger housing.

The tool of the present invention is also provided with a light source 148. The light source is mounted within the interior of the housing and is electrically connected to a battery (not shown) and to actuation button 150 in a manner known in the art. The button is accessible through back wall opening 66 which is located in depression 64 for selective activation of the light source. The front wall includes an access panel 68 for accessing the housing interior to replace the battery as needed. The light source is aligned with an aperture 152 in the first side wall 18 and projects light beams through the aperture when activated.

If it is not important to include a light with the present invention, the housing interior area enclosing the light source can be left empty. The area can then be used to store staples, paper clips, refill lead and the like. In such case, back wall opening 66 and light aperture 152 will be enclosed and removable access panel 68 may be converted to a more convenient transparent hinged door with a friction catch. Alternatively, any or all of the sidewall, bottom wall, top wall, front wall or back wall portions of the housing can be transparent, according to design considerations for viewing the storage area and/or consumer aesthetics.

From the above descriptions, it can be seen that the implement, stapler and punch for the multi-purpose tool of the present invention can be rendered more effective through their cooperating relationship with the same housing in which they are stowed. This feature also permits the housing to be thin and readily carried in one's purse or in a shirt pocket. The housing can also be carried on a key chain.

While the particular multi-purpose tool, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. A multi-purpose tool comprising:
a housing;
a stapler detachably mounted to said housing, said stapler having an actuating member; and,
a recess in said housing that is engageable with said actuating member when said stapler is mounted to said housing.

2. The tool of claim 1 wherein said housing has a first side wall and a bottom wall and further wherein said recess is defined by an inclined wall that extends from said first side wall into a curved portion, said curved portion merging into an end wall that terminates at said bottom wall.

3. The tool of claim 2 wherein said recess is formed with at least two opposing undercut slots that extend from said first side wall along said inclined wall and said curved portion, said slots terminating at said end wall.

4. The tool of claim 3 further comprising at least two opposing flanges extending longitudinally along said actuating member for frictional engagement with a corresponding undercut slot when said stapler is mounted to said housing.

5. The tool of claim 3 wherein said slots have a decreasing width along said inclined wall.

6. The tool of claim 5 wherein said curved portion defines a transition area and said width diminishes in said transition area.

7. The tool of claim 4 wherein said stapler has a base and said base is about flush with said bottom wall when said stapler is mounted to said housing.

8. The tool of claim 7 wherein said actuating member has an outwardly extending tab and wherein said housing is formed with an indentation on said bottom wall extending rearwardly from said end wall, said tab being engageable with said indentation when said stapler is mounted in said recess.

9. The tool of claim 1 wherein said housing includes a corner opening and further comprising:
a hole punch; and,
a means for selectively fixing said hole punch in said corner opening.

10. The tool of claim 9 wherein said holding has a front wall and a rear wall, wherein said holding means comprises a first guide rail formed in said front wall and a second guide rail formed in said rear wall, and wherein said punch includes a punch casing having opposing grooves that frictionally engage said guide rails when said hole punch is inserted into said corner opening and fixed to said housing.

11. The tool of claim 1 wherein said housing has an aperture and further comprising:
a lighting means mounted within said housing and oriented for illumination through said aperture; and,
an activation means attached to said housing and electrically connected to said lighting means for selective illumination of said lighting means.

12. A method of using on a multi-purpose tool on a work piece whereby said tool has an detachably mounted implement in a palm-sized housing comprising:
A. providing an implement with an actuating member;
B. forming a recess in said housing that is engageable with said actuating member when said implement is mounted to said housing;
C. mounting said implement to said tool;
D. engaging said work piece with said implement; and,
E. imparting a force on said housing.

13. The method of claim 12 further comprising the steps of:
F. removing said implement from said housing;
G. re-engaging said work piece with said implement; and,
H. operating said actuating member.

14. A multi-purpose tool comprising:
a housing;
a hole punch detachably mounted to said housing, said hole punch including a punch casing; and,
a corner opening in said housing that is engageable with said punch casing when said hole punch is mounted to said housing.

15. The tool of claim 14 wherein:
said housing has a front wall and a rear wall;
said corner opening has at least two opposing guide rails, each guide rail extending from a respective front wall and rear wall and extending into said corner opening; and,
said punch casing includes at least two grooves, said grooves frictionally engaging a corresponding guide rail when said hole punch is mounted to said housing.

16. The tool of claim 14 wherein said housing has an aperture and further comprising:
a lighting means mounted within said housing and oriented for illumination through said aperture; and,
an activation means attached to said housing and electrically connected to said lighting means for selective illumination of said lighting means.

17. The tool of claim 14 wherein said housing is formed with a recess and further comprising;
a stapler having an actuating member; and,
a retaining means for engagement with said actuating member to releasably hold said stapler in said recess.

18. The tool of claim 17 wherein said housing has a first side wall and a bottom wall and further wherein said recess is defined by an inclined wall that extends from said first side wall into a curved portion, said curved portion merging into an end wall that terminates at said bottom wall.

19. The tool of claim 18 wherein said recess is formed with a pair of opposing undercut slots that extend from said first side wall along said inclined wall and through said curved portion, said slots terminating at said end wall.

20. The tool of claim 19 wherein said curved portion defines a transition area and said slots have a width, said width diminishing in said transition area.
